(19) United States
(12) Patent Application Publication
(10) Pub. No.: US 2006/0113849 A1
(43) Pub. Date: Jun. 1, 2006

(54) Motor having cores structure wherein magnetic circuit is designed in three dimensional configuration

(76) Inventors: Yuji Enomoto, Hitachi (JP); Noriaki Hino, Mito (JP); Shouichi Kawamata, Hitachi (JP); Kazumasa Ide, Hitachiota (JP); Yasuo Matsuda, Hitachi (JP); Toshihiko Sakai, Yokohama (JP)

Correspondence Address: CROWELL & MORING LLP;INTELLECTUAL PROPERTY GROUP, P.O. BOX 14300, WASHINGTON, DC, 20044-4300, US

(21) Appl. No.: 11/326,457

(22) Filed: Jan. 6, 2006

Related U.S. Application Data
(63) Continuation of application No. 10/641,391, filed on Aug. 15, 2003, now abandoned.

(30) Foreign Application Priority Data
Nov. 1, 2002 (JP) 2002-319287

(51) Int. Cl. H02K 41/00; H02K 15/12; H02K 21/12

(52) U.S. Cl. 310/44; 310/156.45; 310/156.32; 310/12; 310/156.64; 310/156.43

(57) ABSTRACT

In order to provide a motor characterized by a high level of efficiency equal to or better than that of using the silicon steel plate, achieved by easy production method and reduced core loss, which result from reduction in the manpower for production by using the sintered metal or powdered iron core in at least one of the stator and rotor, the present invention provides a motor comprising a stator and a rotor wherein either one of said stator or rotor has a magnet, and the other has a magnetic substance. This motor is further characterized in that the main magnetic flux flowing between the stator and rotor changes in the three-dimensional directions according to the magnetic structure of this motor, and at least part of said magnetic substance is composed of an aggregate of magnetic powder.

### BACKGROUND OF THE INVENTION

1. Field of the Invention

The present invention relates to a new motor having core structure of a stator or a rotor wherein the magnetic circuit is designed in a three dimensional configuration, for example, in a stepping motor, linear motor, brush-less motor and axial gap motor.

2. Prior Art

[Patent Literature 1] Japanese Application Patent Laid-open Publication No. Hei 05-308768

[Patent Literature 2] Japanese Application Patent Laid-open Publication No. Hei 08-242572

[Patent Literature 3] Japanese Application Patent Laid-open Publication No. Hei 09-56139

[Patent Literature 4] Japanese Application Patent Laid-open Publication No. Hei 09-65638

[Patent Literature 5] Japanese Application Patent Laid-open Publication No. Hei 09-182329

[Patent Literature 6] Japanese Application Patent Laid-open Publication No. Hei 09-233737

[Patent Literature 7] Japanese Application Patent Laid-open Publication No. Hei 11-127548

A motor comprises a core made of magnetic material and a coil as a conductor. In order to reduce eddy current and to increase saturated magnetic flux density, the soft magnetic core is generally made by lamination of thin silicon steel sheets composed of steel containing silicon in many cases. Basically, any soft magnetic substance can be used to produce a motor core. So if the motor efficiency can be reduced, it is possible to manufacture the core using a material of low magnetic permeability or steel block. However, there is virtually no example where such a material is used in a product.

The prior art of the above-mentioned motor is disclosed in the [Patent Literature 2] where a powdered iron core is used as a stator core, and in the [Patent Literature 3] and [Patent Literature 4] where sintered powdered iron core is used to make the stator core of a stepping motor. These literatures disclose the method of producing a motor using a powdered iron core. The stator configuration according to these literatures is based on the method for manufacturing a motor by replacing the stator core of a general motor with a powered ion core.

The [Patent Literature 1] shows an example of using a powdered iron core to make the stator yoke of a stepping motor, and [Patent Literature 5] discloses an example of using a composite sintered substance containing both ferromagnetic and non-magnetic portions to manufacture a rotor. The [Patent Literature 6] gives an example of using the sintered body of soft magnetic material to make a rotor, and [Patent Literature 7] indicates an example of utilizing a hard magnetic metallic glass to produce the rotor of a stepping motor.

### SUMMARY OF THE INVENTION

(Problems to be Solved by the Invention)

In the prior art, giving consideration to the magnetic characteristics of the laminated steel plate, the magnetic circuit of the motor constitutes a magnetic circuit that closes upon flowing of the magnetic flux through the two-dimensional plane. Accordingly, the magnetic path between the stator and rotor is used for the flowing of the magnetic flux through the two-dimensional plan only between them. On the other hand, the soft magnetic material such as powdered iron core or sintered core is structured in such a way that the magnetic substance is present three dimensionally and uniformly in a non-oriented manner; it not structured in such a way that sheets are laminated through an insulation layer. This causes the eddy current with respect to the magnetic flux on the two-dimensional plane to occur on the plane perpendicular to the two-dimensional plane, with the result that the motor efficiency is deteriorated and core temperature is raised.

The maximum saturated magnetic flux density and magnetic permeability of the powdered iron core or sintered core are lower than that of the iron. This requires greater magnetic field intensity to get the same magnetic flux density. This results in an increased current value, reduced motor efficiency and greater core loss causing a higher coil temperature.

Further, because of insufficient mechanical strength and vulnerability to impact or excessive stress, the magnetic characteristics are reduced if there is an increase in the amount of resin as a binder.

Thus, the object of the present invention is to provide a motor characterized by a high level of efficiency equal to or better than that of using the silicon steel plate, achieved by easy production method and reduced core loss, which result from reduction in the manpower for production by using the sintered metal or powdered iron core in at least one of the stator and rotor.

(Means for Solving the Problems)

Paying attention to the three dimensional, non-oriented features of the magnetic sintered metal or powdered iron core, the present invention provides a motor characterized in that a three dimensional magnetic path is formed to provide the magnetic structure that allows the main magnetic flux flowing between said stator and rotor to be changed in the three-dimensional directions, and a compensatory structure by the three dimensional non-oriented feature is employed in place of the magnetic path only for the two-dimensional plane using the conventional silicon steel plate, whereby the performances equal to or better than those of the one using the conventional silicon steel plate have been realized.

In other words, the present invention permits a three dimensional magnetic path to be formed, and this structure allows a great amount of magnetomotive force of the magnet on the rotor side to be collected by the stator. To put it more specifically, the structure is designed in such a way that the length of the magnet in the axial direction is greater than the laminated thickness of the stator core made of the magnetic sintered metal in the axial direction, and a great amount of magnetic flux can be collected from the magnet by the end of the core in the direction of laminated thickness. Further, even when the length of the magnet is the same as the laminated thickness of the tip of the stator core tee, the magnetic flux entering from the tee tip can be increased as a coil flux linkage if the laminated thickness of the portion where a coil is wound is reduced below the length of the magnet.

The present invention provides a motor comprising a stator and a rotor wherein either one of the above-mentioned stator or rotor has a magnet, and the other has a magnetic substance. This motor is characterized in that the density of the main magnetic flux flowing between the above-mentioned stator and rotor changes in the three-dimensional directions according to the magnetic structure of this motor. To put it more specifically, this motor is designed to have a magnetic structure in such a way that the density of the main magnetic flux flowing between the above-mentioned stator and rotor changes in the three-dimensional directions, and at least part of the above-mentioned magnetic substance is composed of an aggregate of magnetic powder.

It is preferred that the aggregate of magnetic powder of the present invention be made of powdered iron core or sintered metal. Powdered iron core is formed into a predetermined shape by an organic resin binder or an inorganic binder, using the magnetic powder with or without oxide film. In the similar manner, the sintered metal is formed by sintering of magnetic powder.

Further, the present invention provides a motor comprising a stator and a rotor wherein either one of the above-mentioned stator or rotor has a magnet, and the other has a magnetic substance. This motor is characterized in that part of the magnetic substance is composed of an aggregate of magnetic powder.

Further, the present invention provides a motor comprising a stator and a rotor wherein either one of the above-mentioned stator or rotor has a magnet, and the other has a magnetic substance. This motor is characterized by having a magnetic structure that allows the density of the main magnetic flux to change in the three-dimensional directions, wherein the portion of the above-mentioned magnetic substance where the main magnetic flux in the two-dimensional plane flows is formed by a silicon steel plate, and the portion where the main magnetic flux changes in the three-dimensional directions is formed by a aggregate of magnetic powder.

Still further, the present invention provides a motor comprising a stator and a rotor wherein either one of the above-mentioned stator or rotor has a magnet, and the other has a magnetic substance. This motor is characterized by any one of the following structures: The motor has a magnetic structure where the lengths of the above-mentioned stator and rotor in the axial direction are different. It has a magnetic structure where the lengths of the stator and rotor in the axial direction are different, and at least part of the magnetic substance is composed of an aggregate of magnetic powder. The magnetic substance is formed by powdered iron core or sintered metal being injection-molded integrally to the laminate of the silicon steel plate. At least part of the magnetic substance is composed of bulky magnetic metallic glass. The magnetic substance is formed by bulky magnetic metallic glass being injection-molded integrally to the laminate of the above-mentioned silicon steel plate.

Still further, the present invention provides a motor comprising a stator having a coil wound on a magnetic substance and a rotor having a magnet, wherein this rotor is provided on the outer or inner periphery of the above-mentioned stator. This motor has a magnetic structure where the length of the magnet in the axial direction is greater than that of the stator, and at least part of the magnetic substance is composed of an aggregate of magnetic powder.

Still further, the present invention provides a motor comprising a stator having

a magnetic substance, a coil wound on the above-mentioned magnetic substance, and multiple pole teeth provided on the tip of the magnetic pole of the above-mentioned magnetic substance, and

a rotor having a magnet, magnetic substances located on both sides of the magnet sandwiched in-between and on the outer periphery thereof without contacting each other, and multiple pole teeth provided on the tip of the magnetic pole of the magnetic substance. This motor is further characterized in that at least pat of the magnetic substance of at least one of the stator and rotor is formed by powdered iron core or sintered metal.

For the three dimensional magnetic circuit of the stepping motor or the like, it is possible to use a powdered iron core and sintered metal core to form the core back portion, while the silicon steel plate forming the tee tip and coil is kept unchanged. This can improve overall magnetic permeability, hence motor performances. According to this production method, the tee portion manufactured by the punched laminated layer of the silicon steel plate is set inside the sintered core molding die, and the core back portion is formed by sintering under this condition. The inserted silicon steel plate and sintered core hybrid material are complementary with each other wherever required, thereby allowing the motor efficiency to be improved.

Similarly, for the linear motor and axial gap type motor, the overall motor efficiency can be improved by using the structure where the sintered core and powdered iron core are used in the portion where there are three-dimensional changes in the magnetic flux vector.

To put it specifically, the present invention provides a motor comprising a ring-shaped stator and a ring-shaped rotor wherein either one of said stator or rotor has a magnet, and the other has a magnetic substance. This motor is further characterized in that the main magnetic flux flowing between said stator and rotor changes in the three-dimensional directions according to the magnetic structure of this motor; alternatively, the main magnetic flux flowing between said stator and rotor changes in the three-dimensional directions according to the magnetic structure of this motor, and at least part of the magnetic substance is composed of an aggregate of magnetic powder.

To put it more specifically, the present invention provides a motor comprising a stator having a ring-shaped magnetic substance and multiple coils provided on one of the surfaces, and a rotor having a ring-shaped magnet. This motor is further characterized in that:

a magnetic substance projecting toward the above-mentioned rotor is formed on the inner periphery of the above-mentioned coil;

a magnetic substance projecting toward the above-mentioned rotor is formed on the inner periphery of the above-mentioned coil and at least part of the magnetic substance is composed of powdered iron core or sintered metal; or

a magnetic substance projecting toward the above-mentioned rotor is formed on the inner periphery of the above-mentioned coil and at least part of the magnetic substance is composed of an aggregate of magnetic powder.

Still further, the present invention provides a motor comprising a non-magnetic cylindrical substance, a coil wound on the non-magnetic cylindrical substance in a concentric circle and a ring-shaped magnet on the inner periphery of the cylindrical substance, wherein the oil is embedded in the aggregate of magnetic powder.

As described above, when the bulky material of magnetic metallic glass alloy as a soft magnetic material is used in the motor, the motor efficiency can be improved by the structure where this material is used in the portion where the motor magnetic flux undergoes other than the same plane.

The following describes the magnetic metals constituting the powdered iron core or sintered metal as an aggregate of magnetic powder of the present invention. In any case, the soft magnetic metal power and binder (organic binder) are prepared and are kneaded by a kneader to get a kneaded substance, which is molded by an injection molding machine and is then sintered to produce a magnetic metal product.

The material used include soft steel, Fe—Si based metallic material containing 1.0 through 8.0 wt % Si, more preferably, 1.5 through 6.5 wt % Si, a sendust containing 13 through 8 wt % A added to it, Fe—Si—B based metallic material containing Si in about the same amount as the above and 0.2 through 3 wt % B, Fe—Ni based metallic material containing 70 through 85 wt % Ni or the material with part of Ni replaced by Co. To achieve various objects such as improvement of the magnetic characteristics, it is preferred that at least one of Mn, Cr, Mo, Cu, P, V, Ti, Ga, Zr, Zn and various types of rare-earth elements be added to the above-mentioned material. The average particle diameter of the metal powder used is preferred to be 5 through 100 microns, more preferably, 5 through 50 microns. In any of the metallic powder types, the material with or without oxide film is used.

A binder can be made of the material of olefin based resin such as polyethylene and polypropylene, acryl resin, styrene based resin such as polystyrene, various types of thermosetting resins such as polyamide, polyimide, polyester, polyether, liquid crystal polymer and polyphenylene sulfide or various types of wax and paraffin, or a mixture of two or more of these materials. The amount of binder to be added is about 2 through 50 wt %, more preferably, 2 through 10 wt %.

### BRIEF DESCRIPTION OF THE DRAWINGS

(Description of the Preferred Embodiment)

FIGS. 1A to 1C are perspective view representing an axial gap type motor where sintered metal or powdered iron core according to the present invention is used for a core, and a cross sectional view showing the flow of magnetic flux;

FIGS. 2A to 2B is a drawing representing the flow of magnetic flux of the laminated product of sintered metal or powdered iron core and silicon steel plate;

FIG. 3 is a diagram representing the differences in the magnetic characteristics of the laminated product of sintered metal or powdered iron core and silicon steel plate;

FIGS. 4A to 4C are cross sectional views and perspective view showing the sintered metal or powdered iron core according to the present invention used to form part of the stator core, and a cross sectional view showing the manufacturing method;

FIG. 5A to 5C are perspective views showing a stepping motor having a three dimensional magnetic circuit structure where the sintered metal or powdered iron core according to the present invention is used, and a cross sectional view showing the flow of magnetic flux;

FIG. 6A to 6C are perspective views showing the sintered metal or powdered iron core according to the present invention used to form part of the stepping motor having a three dimensional magnetic circuit structure, and a cross sectional view showing the manufacturing method;

FIG. 7 is a perspective view representing an axial gap type motor of the present invention, and a cross sectional view showing the flow of magnetic flux;

FIG. 8A to 8B perspective views showing the sintered metal or powdered iron core according to the present invention used to form part of the axial gap type motor having a three dimensional magnetic circuit structure;

FIG. 9 is a perspective view representing the linear motor of the present invention and the direction of magnetic flux flow;

FIG. 10A to 10B are perspective views and cross sectional view showing the sintered metal or powdered iron core according to the present invention used to form part of the linear motor having a three dimensional magnetic circuit structure; and

FIG. 11 is a chart representing the relationship between magnetic permeability and saturated magnetic flux density of various magnetic materials of the present invention.

### DETAILED DESCRIPTION OF THE INVENTION

### Description of the Preferred Embodiments

### Embodiment 1

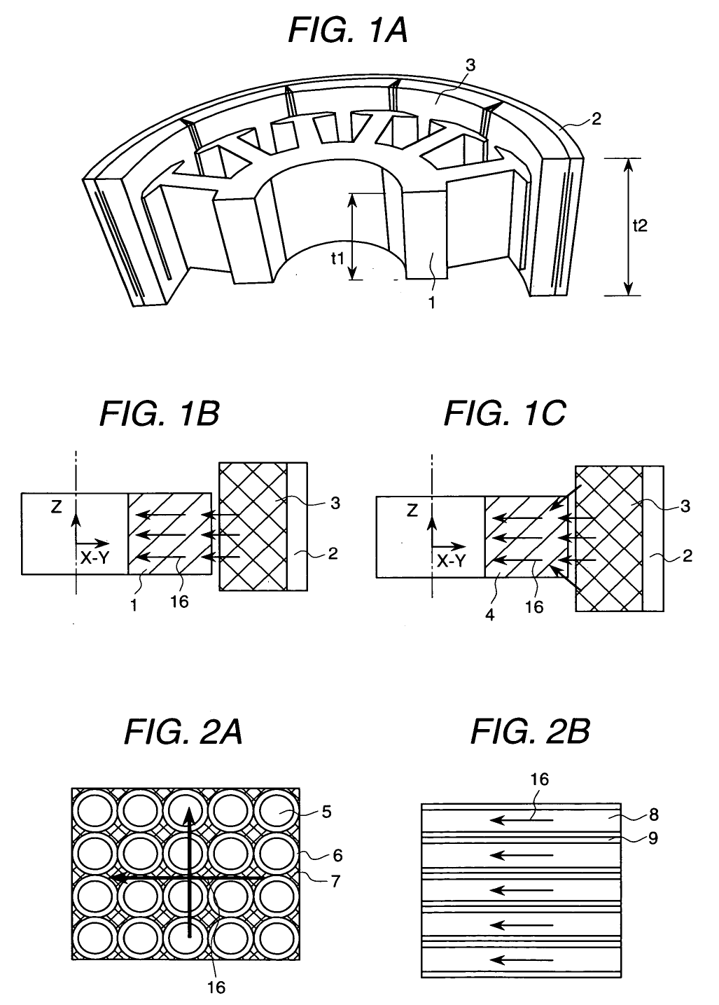

FIGS. 1A to 1C are examples of the epicycloidal motor magnetic motor according to the present invention. FIG. 1A is a partial perspective view of this motor. It shows the structure of a stator core constituting the portion where the magnetic flux vector changes its direction to the space other than the same plane in the magnetic circuit. In the present embodiment, the length (t2) of the rotor magnet 3 in the axial direction is set at 25 mm, while the laminate thickness (t1) of the stator core 1 in the axial direction is set to 15 mm.

FIG. 1B is a cross sectional view representing the prior art motor where silicon steel plates are laminated, and the flow of magnetic flux. In this case, the magnetic flux from the rotor magnet 3 enters the stator core 1 perpendicular to the X-Y plane. So in this two-dimensional plane, magnetic flux flows only to the same area as that of the X-Y plane of the stator core 1.

FIG. 1C is a cross sectional view representing the case where the entire stator core 1 shown in FIG. 1A is composed of sintered metal and powdered iron core. It also shows the flow of the magnetic flux. In this case as illustrated, it can be seen that inflow of the magnetic flux from the rotor magnet 3 into the stator core 1 provides a flow in the two-dimensional direction where there is a change of the magnetic flux in the Z direction other than the change on the X-Y plane. Since the stator 1 is made of sintered metal Order Specification powdered iron core, the easily magnetizable axis in the individual powdery magnetic materials constituting them are formed in the non-oriented manner. The magnetic flux from the rotor magnet 3 can accept the magnetic flux coming along the entire length of the rotor magnet 3 in the axial direction, with the result that motor efficiency can be improved.

FIGS. 2A to 2B are drawings representing the flow of magnetic flux. FIG. 2A is a drawing representing the structure of sintered metal and powdered iron core. FIG. 2B is a model drawing showing the structure of a silicon steel plate. The sintered metal and powdered iron core of the present invention have an insulating layer 6 formed around powder 5 consisting of fine iron powder, as shown in FIG. 2A, and the insulated particles of ion powder are put together by an organic material 7 as a binder to form the sintered metal and powdered iron core. Magnetic flux can be received in any direction along the flow of the magnetic flux from the rotor magnet 3. Further, the prior art silicon steel plate 8 shown in FIG. 2B consists of Fe—Si alloy containing Si. Insulating film 9 made of inorganic or organic material is formed and laminated on its surface. The magnetic flux from the rotor magnet 3 goes in one direction alone.

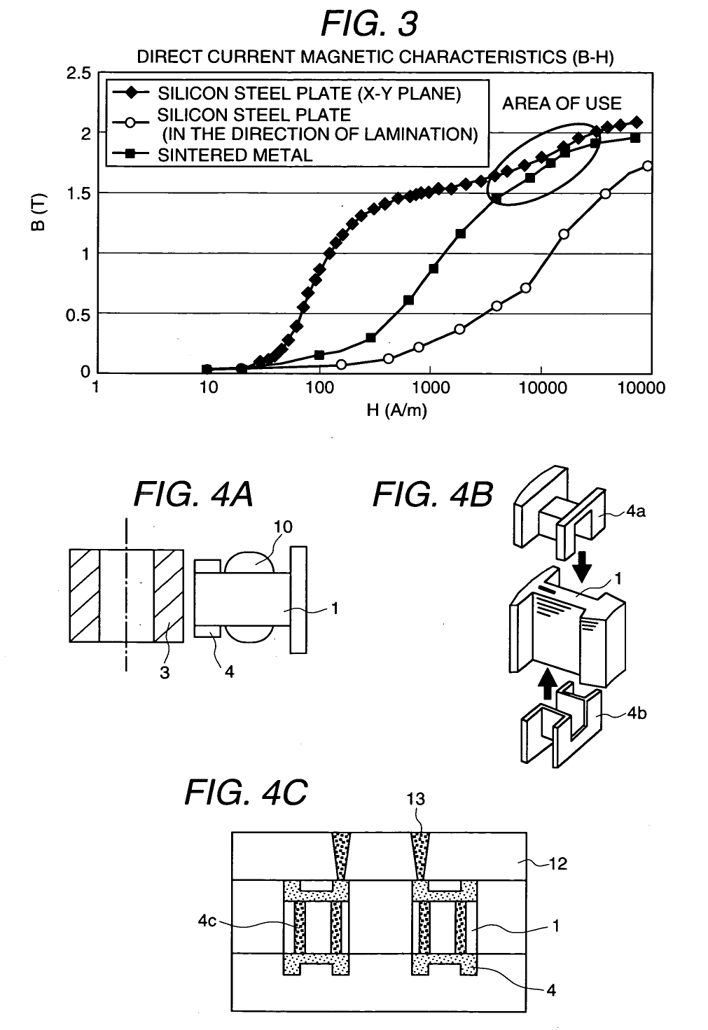

FIG. 3 is a diagram representing the magnetic characteristics of the powdered iron core and silicon steel plate. In the magnetic characteristics of silicon steel plate, the maximum saturated magnetic flux density is high on the X-Y plane, and the magnetic permeability is also high. However, the magnetic characteristics in the direction of lamination are substantially reduced below those in the X-Y plane, although it depends on the space factor of the lamination. On the other hand, the magnetic characteristics of powdered iron core or sintered metal are lower in both the maximum saturated magnetic flux density and magnetic permeability than those of the silicon steel plate in the X-Y plane. However, since the characteristics are non-oriented and are equivalent on the X-Y plane and Y-Z plane, they are much higher than those of the silicon steel plate in the direction of lamination. Accordingly, the motor having the structure shown in FIG. 1C uses the powdered iron core, it becomes possible to capture a wide range of the flow of the magnetic flux of the rotor magnet 3 at the end of the stator core 1 in the Z direction. As shown in FIG. 3, the magnetic characteristics of the powdered iron core or sintered metal at 3,000 through 50,000 A/m are the same on the X-Y plane of the silicon steel plate, exhibiting an excellent characteristics in the Z direction of the silicon steel plate, with the result that motor efficiency is improved.

In the present embodiment, the five types of soft magnetic metallic powder (each of them having an average particle diameter of about 30 microns with or without oxide film on the surface; soft steel, Fe-3.5 wt % Si alloy powder, Fe—Si—B alloy powder with 1% B added to it, Fe—Si—Al alloy (sendust) powder, and F-77 wt % Ni-0.3 wt % Co-1 wt % Si-0.5 wt % Mn alloy (supermalloy), as well as polyethylene as a binder, were prepared. They were mixed so that the mount of binder would be 2 wt %. They were kneaded by a kneader to get the kneaded substance. Then this kneaded substance was molded by an injection molding machine to produce a product shaped as a stator core as shown in FIGS. 1A to 1C. In this case, molding was performed at a die temperature of 140° C. and an injection pressure of 1,000 kg/cm². The molded product obtained in this manner was subjected to the process of removing binders at 400° C. It was then was baked in a vacuum of 1×10⁻⁵ Torr at 300° C. to get a stator core 1 consisting of a metallic sintered body.

### Embodiment 2

FIGS. 4A to 4C are drawings representing an example of a motor in FIGS. 1A to 1C where a hypocycloidal magnet is used. FIG. 4A is a cross sectional view. FIG. 4B is a perspective view showing the assembling procedure. FIG. 4C is a cross sectional view representing the integral formation by injection molding. In the present embodiment, the example shows the case where only the end of the stator core 1 is made of a sintered metal. It shows that the main magnetic flux flowing between the stator core 1 and rotor magnet 3 changes in three-dimensional direction through the sintered metal 4. Further, the silicon steel plate is placed at the center effectively utilizing the characteristics of the silicon steel plate in the X-Y direction. Only a part of the powdered iron core or sintered metal at the tip is supplemented by powdered iron core or sintered metal. The magnetic flux from the rotor magnet 3 provides the flow of a straight magnetic flux leading to the silicon steel plate and that of a magnetic flux in the three dimensional direction leading to the powdered iron core or sintered metal. Normally, the stator core 1 is provided with winding, so the length of the rotor magnet can be greater than the space of the laminated thickness of the stator core 1 in many cases. In such cases, the laminated product of the silicon steel plate alone cannot effectively absorb the magnetic flux of the magnet. So it is a common practice to make sure that the laminated thickness of the stator core 1 is the same as the length of the magnet. It is also possible to arrange the configuration where the magnetic flux of the longer portion of the magnet can be effectively utilized by using the sintered metal and powdered iron core on the end alone.

Since the stator core 1 can be molded by sintering, the shape of the tee can be formed as desired. This makes it possible to arrange the structure in such a way that the tip is thick and coil winding portion is thin. Further, since a binder is used to provide isolation, it can also be used as an insulator. The sintered metal and powdered iron core can be used as a winding bobbin material, as shown in 4B. This structure provides a function as an insulator in addition to the effect of the structure shown in FIG. 4A. When it is used as a winding bobbin material, insulation reliability can be improved by making a thin insulation film by plating or plastic molding, after molding of the sintered metal and powdered iron core. FIG. 4B shows a split product. As shown in FIG. 4C, the entire stator core 1 is formed as an integral body by silicon steel plate.

The following describes the manufacturing method by injection molding when manufacturing the end as shown in FIG. 4C. In addition to the procedure of molding a shape alone, the laminated part of the silicon steel plate is inserted into the die shown in 4C, and sintered metal and powdered iron core shown in FIG. 4B can be formed integrally in one body. In this case, if a through-hole is provided in the laminated steel plate, the molded powdered iron core or sintered metal are filled in the laminate silicon steel plate as a bar 4b of mechanical structure. This increases the mechanical strength as compared to the case where only the end is molded. This structure provides a motor stator of powdered iron core or sintered metal characterized by improved mechanical strength. The materials for sintered metal and powdered iron core are the same as those shown in embodiment 1.

### Embodiment 3

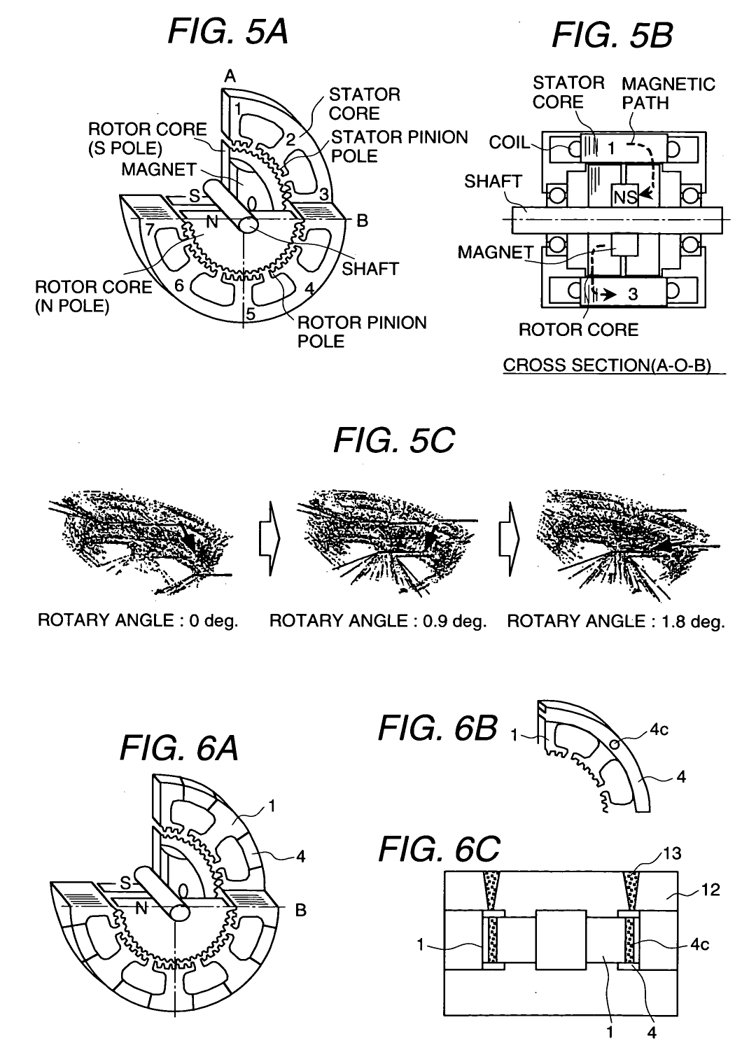

FIG. 5A is a drawing representing an example of using a powdered iron core or sintered metal in the structure of the hybrid (HB) type stepping motor. FIG. 5A is a perspective view, and FIG. 5B is its cross sectional view. FIG. 5C is a drawing representing the magnetic flux vector of the stator showing how the magnetic flux flows. The flow of the magnetic flux of the HOB type stepping motor can be described as follows: Magnetomotive force is provided by the magnet inserted into the rotor, and the magnetic flux emitted from the N pole enters the stator through the portion where the stator core 1 is meshed with the pinion of the rotor (the first pole for (a)), and returns to the position where the stator on the N pole side is meshed with the pinion of the rotor (the third pole for (a)) after passing through the stator. The main magnetic flux flowing between the stator core 1 and rotor magnet 3 changes in the three dimensional direction.

In the present embodiment as shown in FIG. 5B, the powdered iron core or sintered metal according to the present invention is used to integrally form both ends and the outer periphery of the rotor magnet 3 fixed to a shaft 15 surrounding it, without contacting with each other.

Changes in the magnetic flux due to rotation occur as shown in FIG. 5C. On the stator of the HB type stepping motor, changes of magnetic flux occur in the Z direction. However, the material constituting the stator core 1 of this stepping motor is a normal laminated product of silicon steel plate, so both the magnetic permeability and maximum saturated magnetic flux density are low in the Z direction, with the result that motor efficiency is reduced. However, the present embodiment allows the efficiency to be improved by manufacturing the stator core of this motor using the powdered iron core or sintered metal. When the entire stator core is to be manufactured using the powdered iron core or sintered metal, the increase in the incoming magnetic flux must be taken into account, for example, by increasing the volume (increasing the laminated thickness) in the pinion on the tee tip, as described in Embodiment 1.

Observation of the changes in the magnetic flux vector in FIG. 5 reveals that the changes of magnetic flux in the Z direction is large only in the core back portion of the stator core 1. This indicates that the efficiency can be improved by using the powdered iron core or sintered metal only in this core back portion. This core back portion originally does not require such a high magnetic flux density that causes the silicon steel plate to be saturated. Accordingly, the magnetic characteristics of the powdered iron core or the like are sufficient, and this also provides an advantage.

In this embodiment, for part or whole of either or both of the stator core 1 and rotor, a magnet and magnetic substance are formed on the one hand, and a magnetic substance on the other. The magnetic substance is formed by the powdered iron core or sintered metal according to the present invention.

FIG. 6A is a perspective view where only the core back portion of the stator core 1 is formed by the powdered iron core or sintered metal. FIG. 6B is a cross sectional view showing the production method. As shown in FIG. 6A, the tee portion required to provide a high level of magnetic flux density and its surrounding area are formed by silicon steel plate (in some cases, bobbin shape is used as an supplement as in Embodiment 1), and the core back section between the tee sections is formed by powdered iron core or sintered metal. In this case, there is an assembling method where parts are manufactured and are bonded together. The silicon steel plate is used in the tee section of the stator core 1, as shown in FIG. 6B, and the entire core back portion is formed integrally by the powdered iron core or sintered metal. As shown in FIG. 6C, the silicon steel plate of the tee section of the stator core 1 is inserted into the die, and the entire core back portion is manufactured according to the method for injection molding of the powdered iron core or sintered metal integrally. At the same time, this method allows the mechanical strength of the molded product to be improved. The materials of the sintered metal or powdered iron core are the same as those described for Embodiment 1.

### Embodiment 4

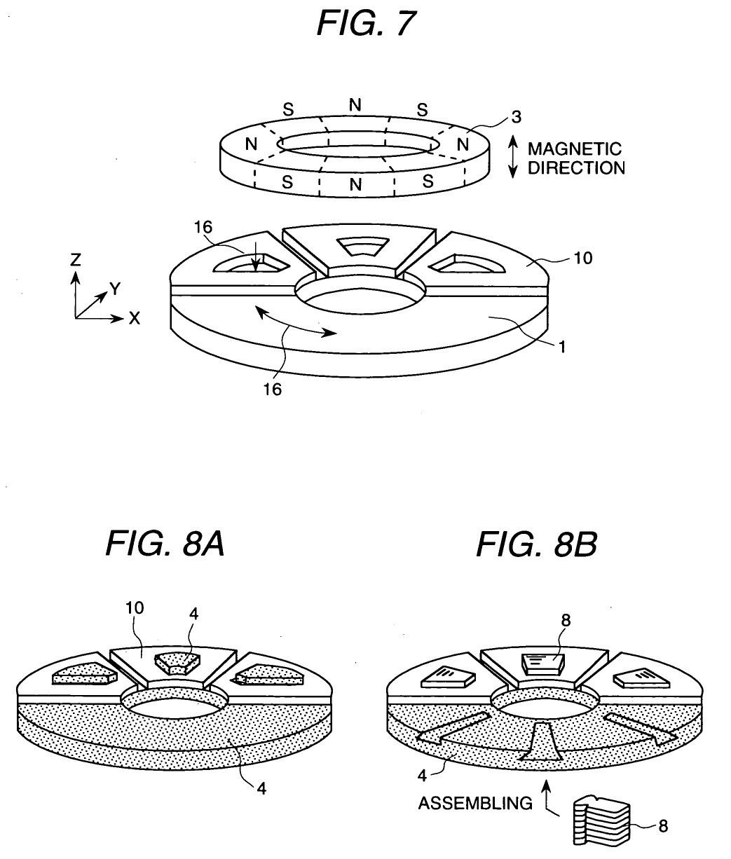

FIG. 7 is perspective view representing the structure of the axial gap type motor according to the present invention. The present embodiment shows an example of using the powdered iron core or intermediate for the stator core and rotor of the axial gap type motor. This motor is characterized by being composed of a flat plate ring-shaped rotor magnet 3 and a flat plate ring-shaped stator core 1. A shaft as a rotary shaft is formed on the flat plate ring-shaped rotor magnet 3. The flow of the main magnetic flux is three dimensional, as compared to the radial gap type motor (given in FIGS. 1 and 4).

Magnetic flux linked with the coil 10 flows through the wound portion of a coil 10. The magnetic flux linked with the coil 10 flows to the magnetic flux, but it flows in the circumferential direction on the core back portion. This motor is not restricted only to flow of magnetic flux through the X-Y plane alone. So it is difficult to use the silicon steel plate. Generally, such a small-sized motor as a low-profile motor uses an air-core coil, without a magnetic substance being used in many cases. To form an axial gap motor in a large-sized motor, use of a magnetic substance is essential. When the stator and rotor is to be formed, use of the powdered iron core or sintered metal is effective.

FIG. 8A to 8B drawing representing an example of the stator of the axial gap type motor where the sintered metal is used. FIG. 8A is a perspective view representing an example of the entire magnetic substance formed by powdered iron core or sintered metal. In this case, the powdered iron core or sintered metal is integrally molded with the stator core 1 and the tee top projecting from the inner periphery of the coil 10 so that there is no joint or assembling structure. In the drawing, the lower half of the stator core 1 is omitted. It has the same structure as the upper half. This is intended to meet the mechanical strength sufficient to withstand this suction force since magnetic suction force greater than the rotational torque acts on the tee as one of the characteristics of an axial gap motor. The powdered iron core or sintered metal has a mechanical strength lower than that of the steel plate, and this makes it necessary to improve the strength by using an integral structure.

FIG. 8B is a perspective view representing the structure of supplementing part of the core back portion by the powdered iron core or sintered metal. In the drawing, the lower half of the stator core 1 is omitted. It has the same structure as the upper half. Because only the tee base of the core back section causes a 90-degree change in magnetic flux vector, this portion is supplemented by powdered iron core or sintered metal, and others are projected to the inner periphery of the coil 10. The silicon steel plate is placed in the axial direction to perform lamination in the radial direction, whereby highly effective motor can be obtained. This manufacture is possible according to the parts assembly and insert molding methods as shown in Embodiments 1 and 2.

### Embodiment 5

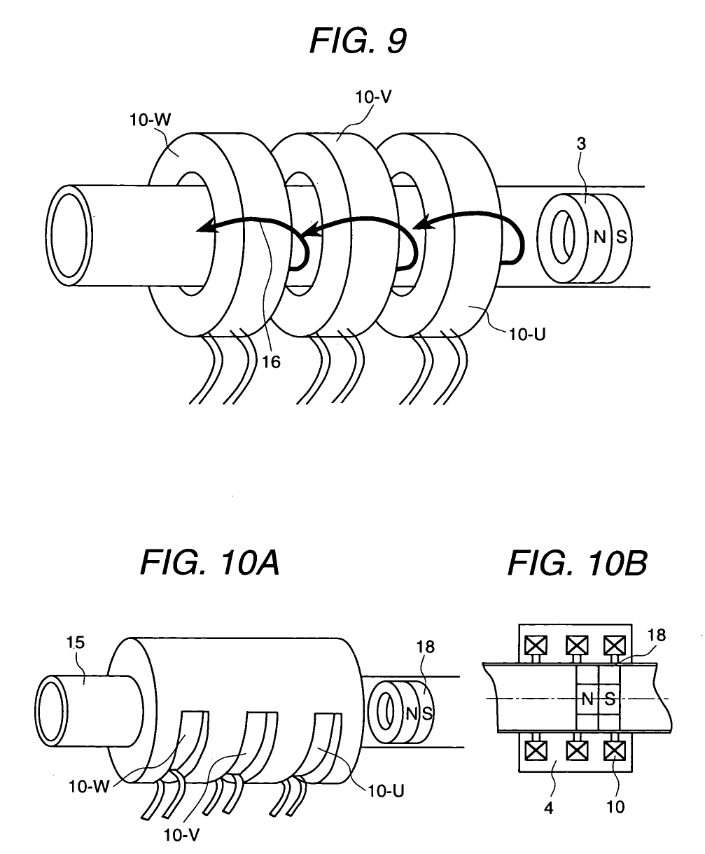

FIG. 9 is a perspective view representing the linear motor characterized by the three dimensional structure. The powdered iron core or sintered metal can be used for various types of linear motors. As described above, this linear motor is not restricted only to the changes in the magnetic flux on the X-Y plane, so motor efficiency can be improved by using the powdered iron core or sintered metal for the entire magnetic substance or the portion where changes in magnetic flux are three dimensional.

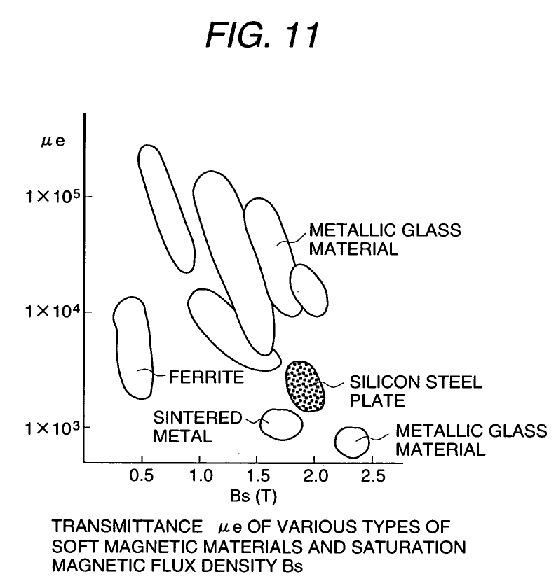

FIG. 10A to 10B are drawings representing an example of the present invention where three coils of a linear motor are covered with sintered metal to achieve integral formation. FIG. 10A is a perspective view representing the overall structure where three coils are partly opened. FIG. 10B is a cross sectional view of the same. The above-mentioned manufacturing method can be used in this case. In the present embodiment, three coils 10-U, 10-V and 10-W are integrally formed by using the powdered iron core or sintered metal as a magnetic substance. This allows an effective operation of the main magnetic flux whose changes are three dimensional, with the result that positioning accuracy of the magnet 3 can be improved.

### Embodiment 6

FIG. 11 is a drawing representing the relationship between magnetic permeability (μe) and saturated magnetic flux density (T) of various magnetic materials. The magnetic substance includes a magnetic metallic glass material, which can have a higher magnetic flux density and magnetic permeability than the silicon steel plate, as shown in FIG. 11. This material permits a further improvement of the motor efficiency through the use in the motor of a three dimensional structure that has a non-oriented feature in a three dimensional manner, in place of the powdered iron core or sintered metal according to the embodiments 1 through 5, or through the local use in the portion where there is a change in three dimensional magnetic flux. Further, this material has an extremely high core loss characteristic, so it provides a substantial improvement of motor efficiency through reduction of core loss, and permits the motor to be designed in more compact configuration. Further, there is no core loss (eddy current loss or hysteresis loss) even in the high frequency area, so this material ensures a substantial improvement in the efficiency of such a high frequency pulse dive motor as a high-speed motor and stepping motor.

### EFFECTS OF THE INVENTION

The present invention improves the efficiency of a motor equipped with a three dimensional magnetic path and reduces the size of the motor. Since powdered iron core or sintered metal can be manufactured by molding operation, it will save manpower and will improve the yield of materials, without the motor performances being lost, as compared to the structure of a punched lamination layer, with the result that an economical motor will be provided. Further, the present invention provides the structure that improves the space factor of the winding and allows the winding to be enclosed with an iron core. This ensures that heat generated from the coil is discharged by heat conduction to the core, and provides a motor characterized by excellent temperature characteristics. At the same time, this will ensure a substantial improvement in efficiency of a high frequency motor due to reduced core loss.

1. A motor comprising a ring-shaped stator and a ring-shaped rotor wherein either one of said stator or rotor has a magnet, and the other has a magnetic substance; said motor characterized in that the main magnetic flux flowing between said stator and rotor changes in the three-dimensional directions according to the magnetic structure of said motor.

2. A motor as defined in claim 1, wherein
said motor characterized in that the main magnetic flux flowing between said stator and rotor changes in the three-dimensional directions according to the magnetic structure of said motor, and at least part of said magnetic substance is composed of an aggregate of magnetic powder.

3. A motor comprising:
a stator having a ring-shaped magnetic substance and multiple coils provided on one of the surfaces, and
a rotor having a ring-shaped magnet;
said motor characterized in that a magnetic substance projecting toward said rotor is formed on the inner periphery of said coil.

4. A motor as defined in claim 3; wherein
said motor characterized in that a magnetic substance projecting toward said rotor is formed on the inner periphery of said coil, and at least part of said magnetic substance is composed of an aggregate of magnetic powder.

5. A linear motor comprising a non-magnetic cylindrical substance, a coil wound on said non-magnetic cylindrical substance in a concentric circle and a ring-shaped magnet on the inner periphery of said cylindrical substance, wherein said oil is embedded in the aggregate of magnetic powder.

6. A motor comprising a ring-shaped stator and ring-shaped rotor, wherein either one of said stator or rotor has a magnet, and the other has a magnetic substance; said motor characterized in that at least part of said magnetic substance is composed of an aggregate of magnetic powder.
